(19) United States
(12) Patent Application Publication
(10) Pub. No.: US 2007/0240089 A1
(43) Pub. Date: Oct. 11, 2007

(54) Apparatus and method for correcting layout pattern data

(75) Inventor: Akihito Tanaka, Tokyo (JP)

Correspondence Address: FOLEY AND LARDNER LLP;SUITE 500, 3000 K STREET NW, WASHINGTON, DC, 20007, US

(73) Assignee: ELPIDA MEMORY, INC.

(21) Appl. No.: 11/727,738

(22) Filed: Mar. 28, 2007

(30) Foreign Application Priority Data
Apr. 10, 2006 (JP) 2006-107729

(51) Int. Cl. G06F 17/50; G06F 9/455

(52) U.S. Cl. 716/11

(57) ABSTRACT

A correcting apparatus of a layout pattern data includes a storage unit configured to store a layout pattern data having a hierarchical structure of cells; and a processing unit configured to correct the layout pattern data. The processing unit corrects the layout pattern data in units of cells, determines whether each of the cells of the layout pattern data after the correction has a same shape as another cell, sets the cells determined to have the same shape to be an identical cell, and re-establishes a hierarchical structure of the cells after the correction.

### BACKGROUND OF THE INVENTION

1. Field of the Invention

The present invention relates to an apparatus for correcting a layout pattern data, and a method of correcting the same.

2. Description of the Related Art

A technique for correcting an input figure data is known. Such a technique is used to overcome a proximity effect in a lithography process in a method of manufacturing a semiconductor device. As the input figure data, there is a case of using a data having a cell hierarchy structure in order to decrease a data amount. As the correcting method, there are two cases, that is, a (A) case of removing the cell hierarchy structure, dividing the figure into a plurality of regions and processing as a flat data; and a (B) case of utilizing the cell hierarchy structure of the input data and processing.

The (A) method of processing as the flat data requires a large amount of data at both the times of correcting and outputting since the correcting process is required for all figures. On the other hand, the (B) method of utilizing the cell hierarchy structure can omit the correcting process when a plurality of same cells (the cells where the shapes of the figures are same) are arranged. It is not always required to perform the correcting process of all of the figures. Thus, a time necessary for the processing and a hardware resource amount can be saved. For these reasons, as compared with the (A) method of processing as the flat data, the (B) method of utilizing the cell hierarchy structure is used in many cases. As the (B) method of utilizing the cell hierarchy structure, a proximity effect correcting method is known which is disclosed in Japanese Laid Open Patent Application (JP-A-Heisei 3-80525).

FIG. 10 is a diagram showing an operation flow of the (B) correcting method in case of utilizing the cell hierarchy structure. At first, figure data having the cell hierarchy structure is inputted. Subsequently, the figure data is divided into internal process cells. Then, the correcting process is performed for each cell. When the correcting process has been completed for all of the cells, the result is outputted. Predetermined processes such as a displaying process on a displaying apparatus and a storing process in a memory are performed on the output result. A specific operation of the correcting process is performed by a method shown in FIG. 11, for example, in case of a proximity effect countermeasure at a lithography step of a semiconductor device. At first, an exposure simulation is performed on one cell or figure of the figure data, and the shape after the exposure is calculated. In accordance with this result, the figure data is corrected and the exposure simulation is performed again. Then, a subtraction between the input figure data and the corrected figured data is performed as a figure calculation process. If its difference is within a predetermined error range, the process for a next cell or figure is performed. If it is outside the error range, the correction of the figure data and the exposure simulation are performed again.

It should be noted that in case of the correction for the mask shape that is used in the lithography step to the semiconductor device, its peripheral environment is different even in the same cell, when the arranged position is different. Thus, the performance of the same correcting process is not always suitable. Even if a cell is same on the figure data, there are many cases that the cell is treated as a different cell when the arranged position is different, or the hierarchy structure is broken and it is then treated as the flat data. Also, actually, there are many figures that cannot be processed in their original states, such as an array cell. Therefore, the perfect utilization of the cell hierarchy structure in the original figure is difficult, which results in the necessity of the enormous data amount.

### SUMMARY OF THE INVENTION

It is therefore an object of the present invention to provide an apparatus for correcting a layout pattern data, in which an amount of data to be processed or outputted is small, and a method of correcting the same.

In an aspect of the present invention, a correcting apparatus of a layout pattern data, includes a storage unit configured to store a layout pattern data having a hierarchical structure of cells; and a processing unit configured to correct the layout pattern data. The processing unit corrects the layout pattern data in units of cells, determines whether each of the cells of the layout pattern data after the correction has a same shape as another cell, sets the cells determined to have the same shape to be an identical cell, and re-establishes a hierarchical structure of the cells after the correction.

The processing unit may determine whether a number of the cells having the same shape and arranged in a same pitch is equal to or more than a predetermined number, after the reestablishment of the hierarchical structure of the cells, and generate an array from the cells having the same shape and arranged in the same pitch when it is determined that the number of the cells having the same shape and arranged in the same pitch is equal to or more than the predetermined number.

Also, the processing unit may check figures in each of the cells after the reestablishment of the hierarchical structure of the cells, to determine whether a number of the figures having a same shape is equal to or more than a predetermined number, and generate cells from the figures having the same shape when it is determined that the number of the figures having the same shape is equal to or more than the predetermined number.

Also, the processing unit may correct the cells in order, when the layout pattern data is corrected, and performs the determination of whether each of the cells of the layout pattern data after the correction has a same shape as the another cell, after the correction of the cells of the layout pattern data.

Also, the processing unit may correct the cells in order, when the layout pattern data is corrected, and perform the determination of whether each of the cells of the layout pattern data after the correction has a same shape as the another cell, by comparing the shape of the cell after the correction and the shape of each of the cells corrected prior to the cell.

In this case, the processing unit may determine whether a number of the cells having the same shape and arranged in a same pitch is equal to or more than a predetermined number, after the reestablishment of the hierarchical structure of the cells, and generate an array from the cells having the same shape and arranged in the same pitch when it is determined that the number of the cells having the same shape and arranged in the same pitch is equal to or more than the predetermined number. Otherwise, the processing unit may check figures in each of the cells after the reestablishment of the hierarchical structure of the cells, to determine whether a number of the figures having a same shape is equal to or more than a predetermined number, and generate cells from the figures having the same shape when it is determined that the number of the figures having the same shape is equal to or more than the predetermined number.

Also, the processing unit may determine whether there are the cells having the same shape in the layout pattern data before the correction, correct each of the cells having the same shape with a priority, and determine whether the shapes of the cells which have the same shape before the correction are same after the correction, immediately after the correction.

In this case, the processing unit may determine whether a number of the cells having the same shape and arranged in a same pitch is equal to or more than a predetermined number, after the reestablishment of the hierarchical structure of the cells, and generate an array from the cells having the same shape and arranged in the same pitch when it is determined that the number of the cells having the same shape and arranged in the same pitch is equal to or more than the predetermined number.

Otherwise, the processing unit may check figures in each of the cells after the reestablishment of the hierarchical structure of the cells, to determine whether a number of the figures having a same shape is equal to or more than a predetermined number, and generate cells from the figures having the same shape when it is determined that the number of the figures having the same shape is equal to or more than the predetermined number.

In another aspect of the present invention, a method of correcting a layout pattern data having a hierarchical structure of cells, is achieved by correcting a layout pattern data having a hierarchical structure of cells for every cell; by determining whether each of the cells of the layout pattern data after the correction has a same shape as another cell; by setting the cells determined to have the same shape to be an identical cell; and by re-establishing a hierarchical structure of the cells after the correction.

Also, the method may be achieved by further determining whether a number of the cells having the same shape and arranged in a same pitch is equal to or more than a predetermined number, after the reestablishment of the hierarchical structure of the cells; and generating an array from the cells having the same shape and arranged in the same pitch when it is determined that the number of the cells having the same shape and arranged in the same pitch is equal to or more than the predetermined number.

In this case, the method may be achieved by further checking figures in each of the cells after the reestablishment of the hierarchical structure of the cells, to determine whether a number of the figures having a same shape is equal to or more than a predetermined number; and generating cells from the figures having the same shape when it is determined that the number of the figures having the same shape is equal to or more than the predetermined number.

Also, the correcting may be achieved by correcting the cells in order, when the layout pattern data is corrected, and the determining is performed after the correction of the cells of the layout pattern data,

Also, the correcting may be achieved by correcting the cells in order, when the layout pattern data is corrected, and the determining may be achieved by comparing the shape of one of the cells after the correction and the shape of each of the cells corrected prior to the cell.

Also, the method may be achieved by further determining whether a number of the cells having the same shape and arranged in a same pitch is equal to or more than a predetermined number, after the reestablishment of the hierarchical structure of the cells; and generating an array from the cells having the same shape and arranged in the same pitch when it is determined that the number of the cells having the same shape and arranged in the same pitch is equal to or more than the predetermined number.

In addition, the method may be achieved by further checking figures in each of the cells after the reestablishment of the hierarchical structure of the cells, to determine whether a number of the figures having a same shape is equal to or more than a predetermined number; and generating cells from the figures having the same shape when it is determined that the number of the figures having the same shape is equal to or more than the predetermined number.

Also, the method may be achieved by further determining whether there are the cells having the same shape in the layout pattern data before the correction. The correcting may be achieved by correcting each of the cells having the same shape with a priority, and the comparing may be executed immediately after the correction.

The method may be achieved by further determining whether a number of the cells having the same shape and arranged in a same pitch is equal to or more than a predetermined number, after the reestablishment of the hierarchical structure of the cells; and generating an array from the cells having the same shape and arranged in the same pitch when it is determined that the number of the cells having the same shape and arranged in the same pitch is equal to or more than the predetermined number.

In addition, the method may be achieved by further checking figures in each of the cells after the reestablishment of the hierarchical structure of the cells, to determine whether a number of the figures having a same shape is equal to or more than a predetermined number; and generating cells from the figures having the same shape when it is determined that the number of the figures having the same shape is equal to or more than the predetermined number.

### BRIEF DESCRIPTION OF THE DRAWINGS

FIG. 1 is a flow chart showing an operation flow of a correcting apparatus according to a first embodiment of the present invention;

FIGS. 2A, 2B and 2C are diagrams showing figure data;

FIG. 3 is a flow chart showing an operation flow of the correcting apparatus according to a second embodiment of the present invention;

FIG. 4 is a flow chart showing an operation flow of the correcting apparatus according to a third embodiment of the present invention;

FIG. 5 is a flow chart showing an operation flow of the correcting apparatus according to a fourth embodiment of the present invention;

FIG. 6 is a diagram showing generation of an array;

FIG. 7 is a flow chart showing an operation flow of the correcting apparatus according to a fifth embodiment of the present invention;

FIG. 8 is a diagram showing generation of cells;

FIG. 9 is a block diagram showing the configuration of the correcting apparatus for a layout pattern data according to the present invention;

FIG. 10 is a flow chart showing an operation flow of a correcting apparatus in a conventional example; and

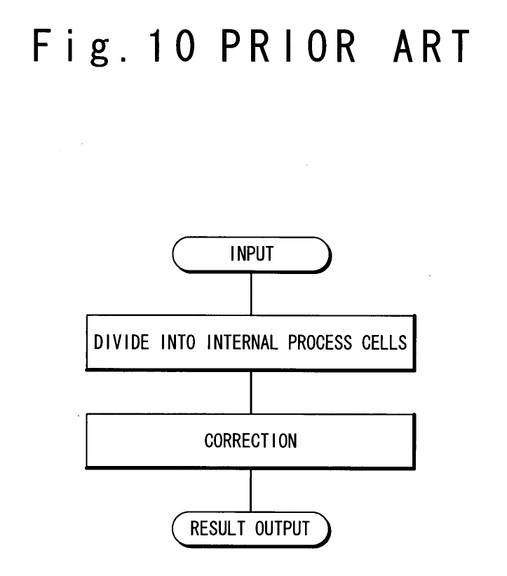

FIG. 11 is a flow chart showing an operation flow of a correcting apparatus in a conventional example.

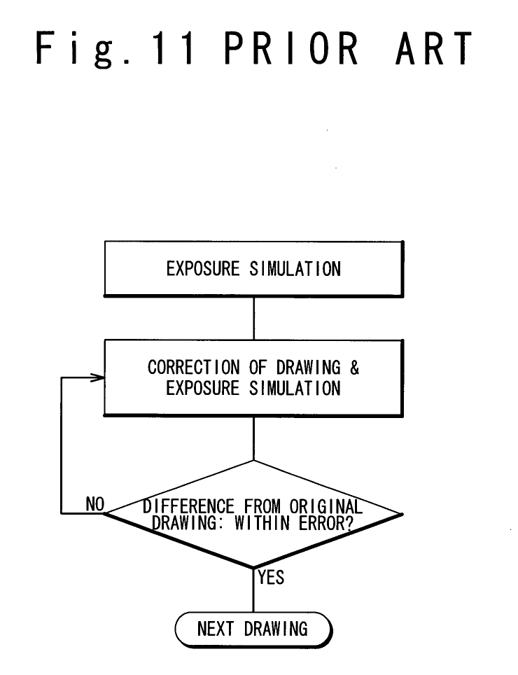

### DESCRIPTION OF THE PREFERRED EMBODIMENTS

Hereinafter, an apparatus 10 for correcting a layout pattern data, according to the present invention will be described in detail with reference to the attached drawings.

### First Embodiment

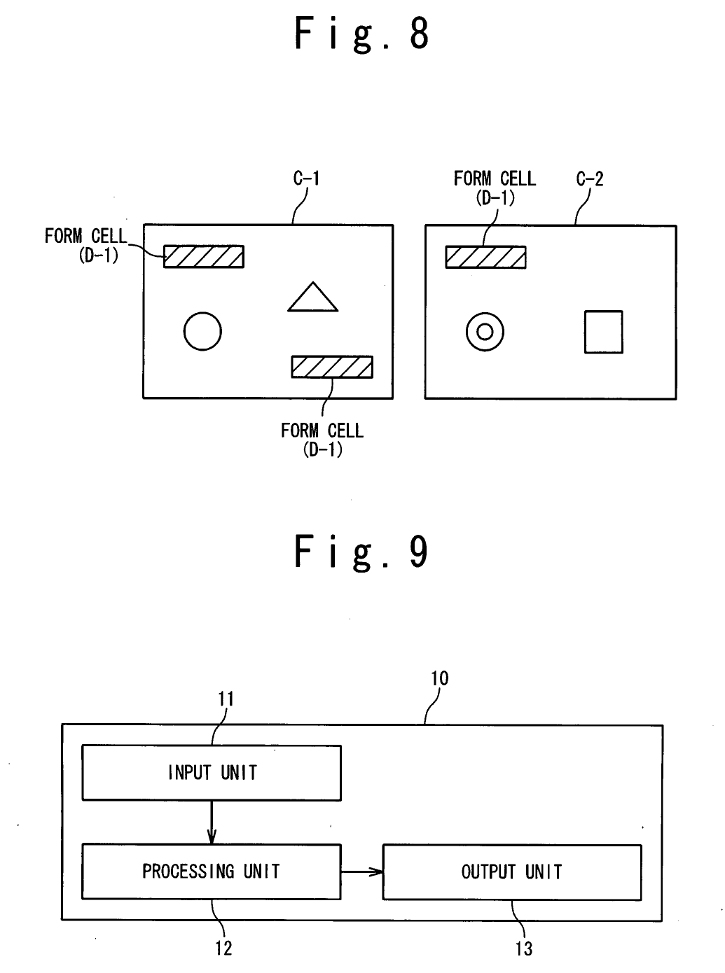

FIG. 9 is a block diagram showing the configuration of an apparatus 10 for correcting a layout pattern data, according to the first embodiment of the present invention. The apparatus 10 has an input unit 11, a processing unit 12 and an output unit 13. It should be noted that in the following description, the correction for a figure data will be described by exemplifying a mask correction as a proximity effect countermeasure in a lithography step of a process of manufacturing a semiconductor device.

The input unit 11 includes a mouth and a keyboard. A user inputs a figure data to be corrected from the input unit 11 and stored in a storage unit (not shown). The processing unit 12 attains a function of correcting the layout pattern data (hereafter, referred to as the figure data) inputted from the input unit 11 or stored in the storage unit. The processing unit 12 is configured to attain the function in cooperation of hardware resources such as CPU and RAM and software resources such as computer programs installed in them. The output unit 13 outputs the figure data corrected by the processing unit 12. It should be noted that the output implies that the corrected figure data is stored in a storage device such as a hard disc or it is displayed on a display apparatus such as a LCD device.

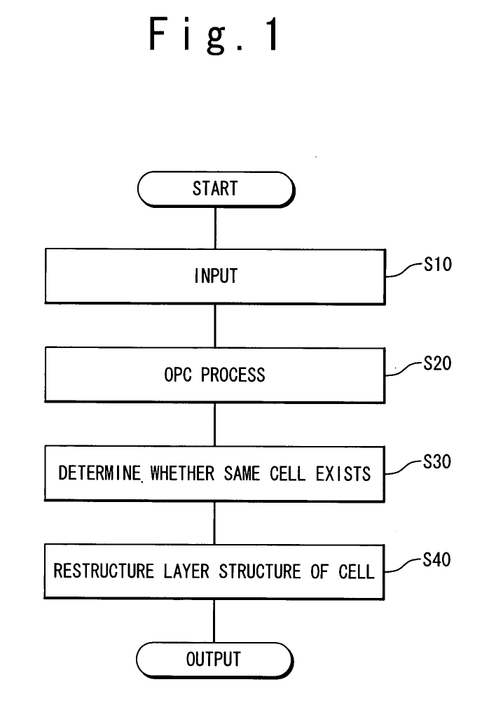

The correcting apparatus attains its function through the following operations. FIG. 1 is a flow chart showing the operation flow of the method of correcting the layout pattern data.

### Step S10: Input of Figure Data

At first, the user inputs the figure data through the input unit 11. The figure data is inputted as a CAD data. The figure data is stored in the storage unit (not shown). The figure data has a hierarchy structure.

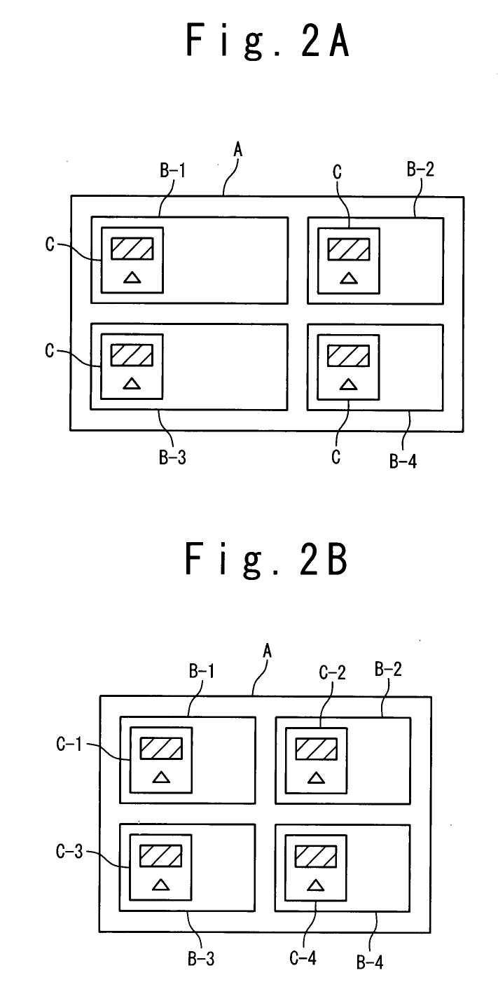

FIG. 2A shows an example of the figure data. The figure data has the most significant cell A in the highest layer of the hierarchy structure. The most significant cell A includes a plurality of cells (B-1 to B-4). Each of the plurality of cells (B-1 to B-4) has a cell (C). A figure is drawn in the cell (C). The figure data has such a cell hierarchy structure. It should be noted that the cells (C) included in the respective cells (B-1 to B-4) have the same shape at the input of the figure data, and they are treated as the same cell.

### Step S20: Correcting Process (OPC Process)

Subsequently, the processing unit 12 performs a correcting process on the figure data. The correcting process is performed in turn from the least significant cell in the lowest layer of the hierarchy structure to the high order cell in the higher layer. In this correction, an exposure simulation is performed on the figure data. Then, by comparing the figure data after the exposure simulation and the figure data, it is possible to determine the post-correction data. It should be noted that in the following description, this correcting process is referred to as the OPC process.

FIG. 2B is a diagram showing the figure data immediately after the OPC process. At the stage prior to the OPC process, the cells (C) included in the respective cells (B-1 to B-4) are all treated as the same cell. However, since the positions where the respective cells (C) are arranged are different, there is a case that the OPC process to be performed is different. For this reason, in the figure data immediately after the OPC process, the cells (C) corresponding to the respective cells (B-1 to B-4) are treated as different cells (C-1 to C-4).

### Step S30: Determination of Whether Cell Having Same Shape Exist

After the OPC process at the step S20 is performed on all of the cells, the processing unit 12 searches the figure data after the performance of the OPC process at the step S20 and determines whether or not there are the cells having the same shape. At the step S20, among the cells treated as the different cells because the different OPC processes are performed in spite of the same cells at the time of the input, there may be the cells having the same shape irrespectively of the performance of the different OPC processes. At this step, whether or not there are the cells treated as the different cells in spite of the same shape is determined. In the following description, in FIG. 2B, the case that the cells C-1, C-3 and C-4 are determined to have the same shape will be described.

### Step S40: Re-Establishment of Cell Hierarchy Structure

The processing unit 12 re-establishes the cell hierarchy structure so that each of the cells C (C-1, C-3 and C-4) determined to have the same shape, is treated as the same cell at the step S30. That is, each of the cells C-1, C-3 and C-4 is substituted by any cell of them. FIG. 2C is a diagram showing the figure data after the re-establishment of the cell hierarchy structure. Each of the cell C-3 and the cell C-4 prior to the re-establishment is substituted by the cell C-1.

The figure data in which the cell hierarchy structure is re-established in the process of the steps S10 to S40 is outputted. The predetermined processes such as the displaying on a display unit, and the storing in the memory are performed on the figure data.

According to this embodiment, the cell hierarchy structure is re-established such that the cells treated as the different cells immediately after the OPC process are treated as the same cells if they have the same shape. Thus, the data amount is decreased. That is, in case of the treatment as the different cells, the shape of the figure in the cell is required to be defined for the cell. However, in case of the treatment as the same cell, the number of the shapes to be written is only one. There is no necessity of writing the shape for each cell, and the number of the shapes to be written in the figure data is reduced.

### Second Embodiment

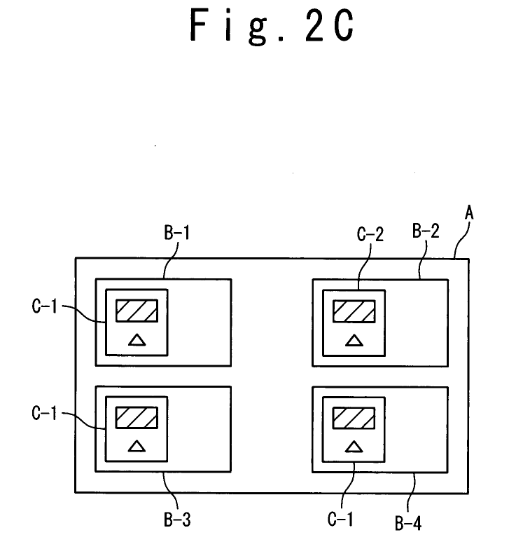

The correcting apparatus according to the second embodiment of the present invention will be described below. Since the configuration of the correcting apparatus according to this embodiment is same as the first embodiment, its explanation is omitted. In this embodiment, the operation performed by the processing unit 12 is further considered as compared with the first embodiment. FIG. 3 is a flow chart showing the operation flow of the method of correcting the layout pattern data according to this embodiment. The operation of the respective steps will be described below in detail. It should be noted that the description of the operation similar to the first embodiment is omitted.

### Step S10: Input of Figure Data

At first, the user inputs the figure data from the input unit 11. This step is similar to the first embodiment.

### Step S15: Recognition of Same Cell

Subsequently, the processing unit 12 analyzes the figure data and examines the hierarchical structure of the cells in the CAD data. Then, the processing unit 12 recognizes whether or not a plurality of same cells are arranged. Moreover, the processing unit 12 determines the order of the cells on which the OPC process is performed. Here, if the plurality of same cells (hereafter, to be referred to as a same cell group) are arranged, the order of the same cell group is preferentially determined such that the OPC process on the same cell group is precedently performed.

### Step S20-1: OPC Process for Same Cell Group

In the process at the step S15, if the same cell group exists, the OPC process is firstly performed on the respective cells in the same cell group.

### Step S30-1: Determination of Whether Resultant Cells in Same Cell Group have Same Shape

At the step S20-1, when the OPC process on all of the cells in the same cell group has been completed, whether or not the respective cells (result cells) after the OPC process in the same cell group have the same shape is determined.

### Step S40-1: Re-Establishment of Cell Hierarchy Structure

At the S30-1, if there are the cells having the same shape among the respective resultant cells in the same cell group, the cell hierarchy structure is re-established such that they are treated as the same cell.

The process on one same cell group is completed through the steps S20-1 to S40-1. After that, in accordance with the order of the OPC process determined at the step S15, the process at the steps S20-1 to S40-1 is repeated for a next same cell group (a different cell, if there is not the same cell group on which the OPC process is not performed). When the process for all of the cells has been completed, the result is outputted.

According to this embodiment, in addition to the effect in the first embodiment, the following effect is accomplished. That is, the cell hierarchy structure of the figure data is analyzed, and whether or not the plurality of same cells are arranged is recognized. Thus, whether or not the shapes after the OPC process are same may be determined only by comparing the cells that are same prior to the OPC process. That is, at the time of the comparison in the step S30-1, the operation for comparing the cells which are different in the input figure data is omitted, which can reduce the work amount necessary for the correcting process.

### Third Embodiment

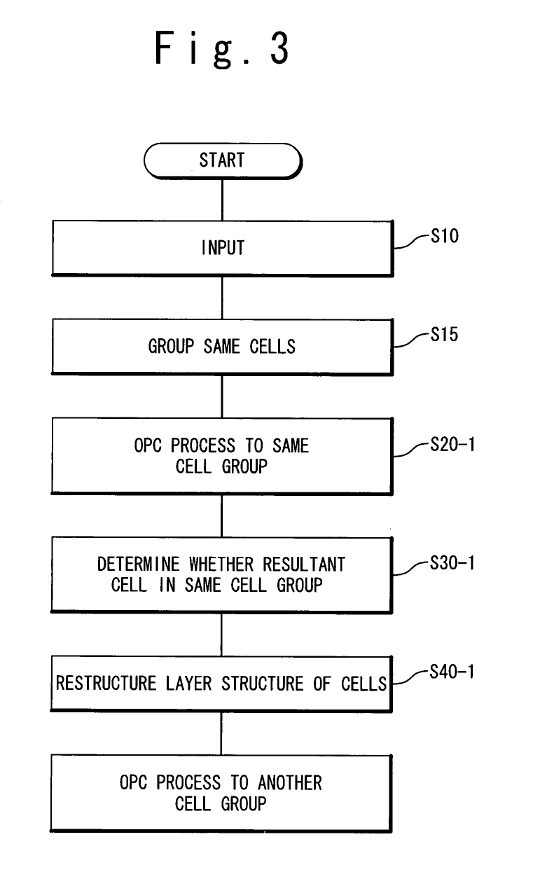

The correcting apparatus according to the third embodiment of the present invention will be described below. Since the configuration of the correcting apparatus for the layout pattern data according to this embodiment is similar to the first embodiment, its description is omitted. In this embodiment, whether or not the cells on which the OPC process is performed are same is determined (Step S30) and the timing when the operation (Step S40) for the cell hierarchy structure is performed is considered as compared with the first embodiment. FIG. 4 is a flow chart showing the operation flow of the method of correcting the layout pattern data according to this embodiment. The respective steps will be described below in detail. It should be noted that the description of the operation similar to the first embodiment is omitted.

### Step S10: Input

Similarly to the first embodiment, the figure data is inputted through the input unit 11 as the CAD data.

### Steps S20 (n=1), 20 (n) to 40 (n): OPC Process

Subsequently, the OPC process is performed on a first cell (step S20 (n=1)). The OPC process is performed in an order from the low order cell to the high order cell. Here, each time the OPC process is performed on each cell (step S20 (n)), the shape comparison with all of the resultant cells of the cells on which the OPC process has been performed prior to this time is performed (step S30 (n)). Then, if there are the cells having the same shape, the cell hierarchy structure is re-established (step S40 (n)). After the step S40 (n), whether or not the cell on which the OPC process has been performed is the most significant cell is determined. If it is not the most significant cell, the OPC process is performed on a next cell. If it is the most significant cell, the result is outputted.

As described in this embodiment, when whether or not the resultant cells have the same shape is determined each time the OPC process has been performed on each of the plurality of cells, the data amount can be also decreased similarly to the first embodiment. Also, in the first embodiment, when the shapes of the resultant cells are compared, the data in which the cell hierarchy structure is not re-established is required to be stored immediately before the comparison. However, in this embodiment, the data to be stored may be only the cell on which the OPC process is already performed. Thus, a middle data size can be further reduced as compared with the first embodiment.

### Fourth Embodiment

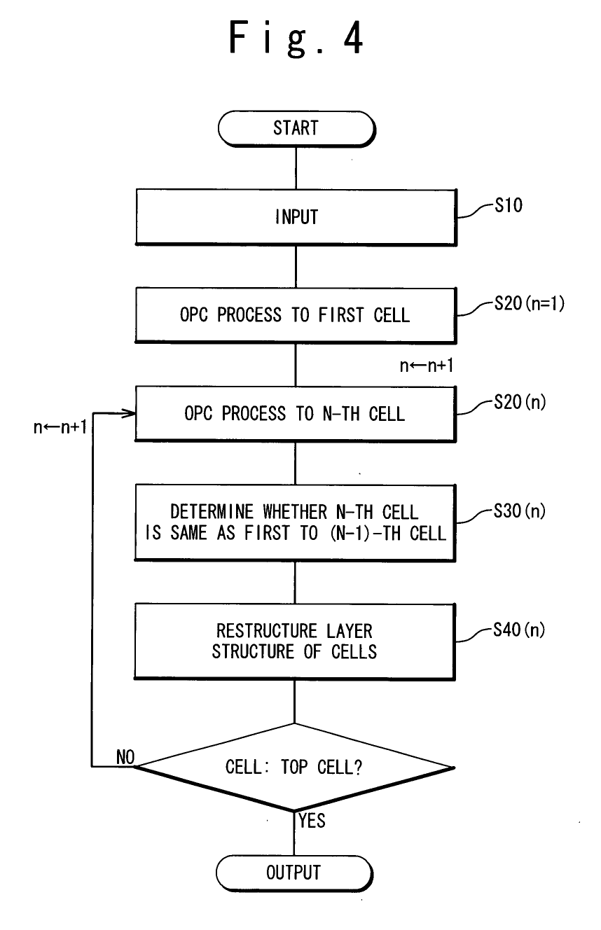

The correcting apparatus according to the fourth embodiment of the present invention will be described below. Since the configuration of the correcting apparatus for the layout pattern data according to this embodiment is similar to the first embodiment, its description is omitted. FIG. 5 is a flow chart showing the operation flow of the method of correcting the layout pattern data according to this embodiment. In this embodiment, steps (Steps S50-1, 50-2) of carrying out an arraying are added to the first embodiment. It should be noted that the operation to the re-establishment of the cell hierarchy structure (Step S40) is the same as that of the first embodiment. Thus, its description is omitted.

### Step S50-1: Recognition of Whether Same Cells are Arranged in Same Pitch

The processing unit 12 determines whether or not the plurality of same cells, the number of which is equal to or greater than a specified number are arranged in a same pitch, for the figure data after the re-establishment of the cell hierarchy structure at the step S40. It should be noted that the specified number is inputted in advance through the input unit 11 by the user and set for a storage device (not shown).

### Step S50-2: Arraying

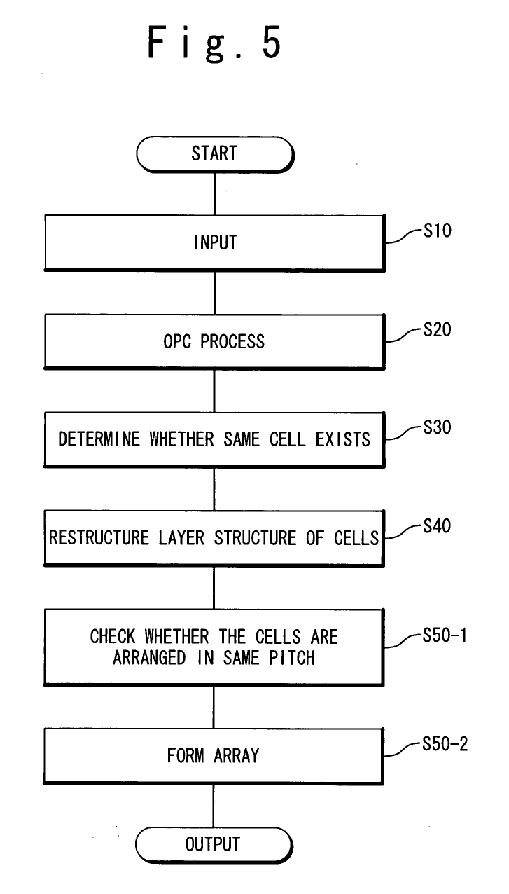

At the step S50-1, if the plurality of same cells are arranged in the same pitch, the plurality of same cells are arrayed. FIG. 6 is a diagram showing the arraying. The plurality of same cells (C-1) are arranged in a constant pitch in the cell B. An array of the plurality of same cells (C-1) is formalized. The arraying is one of the CAD data definition methods, and implies that when the plurality of cells are arranged in the constant pitch, an arrangement data is not individually defined, but it is collectively defined. When the step S50-2 has been completed, the figure data after the completion of the process is outputted similarly to the first embodiment.

According to this embodiment, in addition to the effect of the first embodiment, the arraying is performed, which further reduces the data amount. Also, since the repetition data (the data in which the plurality of same cells are arranged in the same pitch) portion is arrayed, the visibility of the data is improved.

### Fifth Embodiment

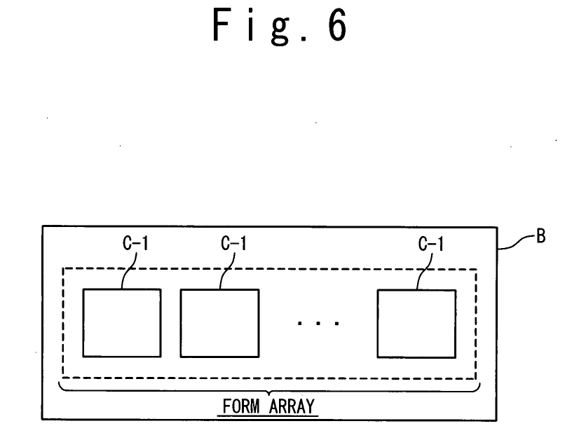

The correcting apparatus according to the fifth embodiment of the present invention will be described below. Since the configuration of the correcting apparatus for the layout pattern data according to this embodiment is similar to the first embodiment, its description is omitted. FIG. 7 is a flow chart showing the operation flow of the method of correcting the layout pattern data according to this embodiment. In this embodiment, the steps (S60-1, 60-2) of searching a figure having the same shape in the cell are added to the first embodiment. It should be noted that the operation to the re-establishment of the cell hierarchy structure (Step S40) is the same as the first embodiment. Thus, its description is omitted.

### Step S60-1: Check of Same Shape Figure in Cell

The processing unit 12 searches figures having the same shape in the cell, and determines whether or not the number of the figures having the same shape is equal to or greater than a predetermined number. Here, the predetermined number is inputted in advance through the input unit 11 by the user and stored in a storage device (not shown).

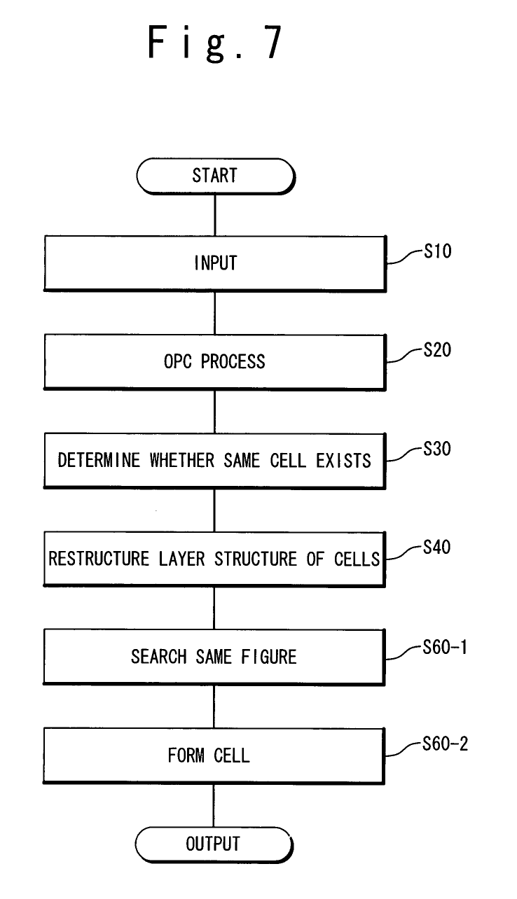

FIG. 8 is a diagram showing the search of the same shape figure in the cell. It is supposed that the figure data after the re-establishment of the cell hierarchy structure includes cell (C-1) and cell (C-2). The cell (C-1) includes two rectangular figures, and the cell (C-2) includes one rectangular figure. It is supposed that those three rectangular figures have the same shape.

### Step S60-2: Cell Making

The processing unit 12 treats the same shape figures, the number of which is equal to or more than the predetermined number as the same cells. In an example shown in FIG. 8, the 3 rectangular figures are represented as 3 same cells (D-1). In this way, the cell hierarchy structure is further established again. After that, similarly to the first embodiment, the figure data in which the hierarchy structure is further established again is outputted.

According to this embodiment, the figures having the same shape in the cell are set as the cells, and treated as the same cells. Thus, the data amount can be further reduced.

It should be noted that the fact that the first to fifth embodiments may be combined optionally in a range without any contradiction, and the multiple effect can be obtained.

What is claimed is:

1. A correcting apparatus of a layout pattern data, comprising:
a storage unit configured to store a layout pattern data having a hierarchical structure of cells; and
a processing unit configured to correct said layout pattern data,
wherein said processing unit corrects said layout pattern data in units of cells, determines whether each of the cells of said layout pattern data after the correction has a same shape as another cell, sets the cells determined to have the same shape to be an identical cell, and re-establishes a hierarchical structure of the cells after the correction.

2. The correcting apparatus according to claim 1, wherein said processing unit determines whether a number of the cells having the same shape and arranged in a same pitch is equal to or more than a predetermined number, after the reestablishment of the hierarchical structure of the cells, and generates an array from the cells having the same shape and arranged in the same pitch when it is determined that the number of the cells having the same shape and arranged in the same pitch is equal to or more than the predetermined number.

3. The correcting apparatus according to claim 1, wherein said processing unit checks figures in each of the cells after the reestablishment of the hierarchical structure of the cells, to determine whether a number of the figures having a same shape is equal to or more than a predetermined number, and generates cells from the figures having the same shape when it is determined that the number of the figures having the same shape is equal to or more than the predetermined number.

4. The correcting apparatus according to claim 1, wherein said processing unit corrects the cells in order, when said layout pattern data is corrected, and performs the determination of whether each of the cells of said layout pattern data after the correction has a same shape as said another cell, after the correction of the cells of said layout pattern data.

5. The correcting apparatus according to claim 1, wherein said processing unit corrects the cells in order, when said layout pattern data is corrected, and performs the determination of whether each of the cells of said layout pattern data after the correction has a same shape as said another cell, by comparing the shape of the cell after the correction and the shape of each of the cells corrected prior to the cell.

6. The correcting apparatus according to claim 5, wherein said processing unit determines whether a number of the cells having the same shape and arranged in a same pitch is equal to or more than a predetermined number, after the reestablishment of the hierarchical structure of the cells, and generates an array from the cells having the same shape and arranged in the same pitch when it is determined that the number of the cells having the same shape and arranged in the same pitch is equal to or more than the predetermined number.

7. The correcting apparatus according to claim 5, wherein said processing unit checks figures in each of the cells after the reestablishment of the hierarchical structure of the cells, to determine whether a number of the figures having a same shape is equal to or more than a predetermined number, and generates cells from the figures having the same shape when it is determined that the number of the figures having the same shape is equal to or more than the predetermined number.

8. The correcting apparatus according to claim 1, wherein said processing unit determines whether there are the cells having the same shape in said layout pattern data before the correction, corrects each of the cells having the same shape with a priority, and determines whether the shapes of the cells which have the same shape before the correction are same after the correction, immediately after the correction.

9. The correcting apparatus according to claim 8, wherein said processing unit determines whether a number of the cells having the same shape and arranged in a same pitch is equal to or more than a predetermined number, after the reestablishment of the hierarchical structure of the cells, and generates an array from the cells having the same shape and arranged in the same pitch when it is determined that the number of the cells having the same shape and arranged in the same pitch is equal to or more than the predetermined number.

10. The correcting apparatus according to claim 8, wherein said processing unit checks figures in each of the cells after the reestablishment of the hierarchical structure of the cells, to determine whether a number of the figures having a same shape is equal to or more than a predetermined number, and generates cells from the figures having the same shape when it is determined that the number of the figures having the same shape is equal to or more than the predetermined number.

11. A method of correcting a layout pattern data having a hierarchical structure of cells, comprising:
correcting a layout pattern data having a hierarchical structure of cells for every cell;
determining whether each of the cells of said layout pattern data after the correction has a same shape as another cell;
setting the cells determined to have the same shape to be an identical cell; and
re-establishing a hierarchical structure of the cells after the correction.

12. The method according to claim 11, further comprising:
determining whether a number of the cells having the same shape and arranged in a same pitch is equal to or more than a predetermined number, after the reestablishment of the hierarchical structure of the cells; and
generating an array from the cells having the same shape and arranged in the same pitch when it is determined that the number of the cells having the same shape and arranged in the same pitch is equal to or more than the predetermined number.

13. The method according to claim 12, further comprising:
checking figures in each of the cells after the reestablishment of the hierarchical structure of the cells, to determine whether a number of the figures having a same shape is equal to or more than a predetermined number; and
generating cells from the figures having the same shape when it is determined that the number of the figures having the same shape is equal to or more than the predetermined number.

14. The method according to claim 11, wherein said correcting comprises:
correcting the cells in order, when said layout pattern data is corrected, and
said determining is performed after the correction of the cells of said layout pattern data,

15. The method according to claim 11, wherein said correcting comprises:
correcting the cells in order, when said layout pattern data is corrected, and
said determining comprises:
comparing the shape of one of the cells after the correction and the shape of each of the cells corrected prior to the cell.

16. The method according to claim 15 further comprising:
determining whether a number of the cells having the same shape and arranged in a same pitch is equal to or more than a predetermined number, after the reestablishment of the hierarchical structure of the cells; and
generating an array from the cells having the same shape and arranged in the same pitch when it is determined that the number of the cells having the same shape and arranged in the same pitch is equal to or more than the predetermined number.

17. The method according to claim 16, further comprising:
checking figures in each of the cells after the reestablishment of the hierarchical structure of the cells, to determine whether a number of the figures having a same shape is equal to or more than a predetermined number; and
generating cells from the figures having the same shape when it is determined that the number of the figures having the same shape is equal to or more than the predetermined number.

18. The method according to claim 11, further comprising:
determining whether there are the cells having the same shape in said layout pattern data before the correction,
said correcting comprises:
correcting each of the cells having the same shape with a priority, and
said comparing is executed immediately after the correction.

19. The method according to claim 18, further comprising:
determining whether a number of the cells having the same shape and arranged in a same pitch is equal to or more than a predetermined number, after the reestablishment of the hierarchical structure of the cells; and
generating an array from the cells having the same shape and arranged in the same pitch when it is determined that the number of the cells having the same shape and arranged in the same pitch is equal to or more than the predetermined number.

20. The method according to claim 19, further comprising:
checking figures in each of the cells after the reestablishment of the hierarchical structure of the cells, to determine whether a number of the figures having a same shape is equal to or more than a predetermined number; and
generating cells from the figures having the same shape when it is determined that the number of the figures having the same shape is equal to or more than the predetermined number.
